(19) United States
(12) Patent Application Publication
(10) Pub. No.: US 2011/0215582 A1
(43) Pub. Date: Sep. 8, 2011

(54) Wind-operated electrical generating system

(76) Inventor: Jorge Parera, Barcelona (ES)

(21) Appl. No.: 12/660,548

(22) Filed: Mar. 2, 2010

(51) Int. Cl. F03D 9/00; F03D 7/06

(52) U.S. Cl. 290/55; 415/48

(57) ABSTRACT

A wind turbine unit for generating electricity in a confined space includes a pair of sails carried at either end of a pair of spaced, axially aligned rotatable arms mounted to the drive shaft of an electrical generator. As the prevailing wind strikes the sails in opposite directions, one of the sails is moved to a vertical position while the other sail is moved to a horizontal position. The wind incident on the then vertical sail causes the arms to rotate about the longitudinal axis of the generator and the sails are alternatively raised and lowered between a vertical and a horizontal position so that one of the sails is vertical while the other is horizontal.

### BACKGROUND OF THE INVENTION

1. Field of the Invention

The present invention relates to wind turbine technology.

2. Description of the Prior Art

Increasing concerns about the adverse effects on the environment produced by the use of fossil fuels to generate electricity, and particularly increases in global warming, have led to increased efforts to develop alternative methods of generating electricity. Among the principal alternatives being used and developed is the use of wind energy to generate electricity, and wind turbines are currently in widespread use to generate electricity in many countries of the world.

The typical wind turbine includes three equiangularly spaced, aerodynamically shaped blades mounted for rotation atop a tower. The blades are mounted at one of their ends to a hub, which, in turn, drives the rotor of an electrical generator. As the prevailing wind passes over the blades they are caused to rotate, which, in turn, causes the rotor to rotate in the generator, thereby to generate electricity. The electricity thus generated is typically collected for transmission by a transmission grid to a local facility from which it is transmitted along power lines to the end users of the electricity.

The conventional wind turbine is relatively large. The tower is typically in the order of 100 meters in height and the blades are typically 60 meters long in order to receive a greater quality and consistency of the wind. Because of their relatively large size, fields of wind turbines, often numbering in the hundreds, are typically located in wide, open areas such as in a desert or in mountainous areas or seashores far from the population areas to which the electricity generated by the wind turbines is to be transmitted. The installation of large fields of wind turbines at these locations has, however, often met with opposition from environmental groups and others areas, such as has recently occurred in Cape Cod, where local residents have objected to what they regard as the destruction of the appearance in their area by the proposed field of wind turbines and the noise the wind turbines produce when in operation.

The large size of the conventional wind turbine has thus limited its installation to open areas far from the end users of the electricity it generates. and has prevented, or at least severely limited, its use in more crowded, urban areas where most users of electricity live. Moreover, the great distances of the wind turbines from the end users of the electricity they generate has required a costly and complex electrical grid and distribution system.

There thus exists a need for a wind turbine having a reduced size that can be used to generate electricity efficiently in crowded urban areas and in wind conditions that would ordinarily be unsuitable for the conventional larger-size wind turbine.

### BRIEF SUMMARY OF THE INVENTION

The present invention is directed to a wind turbine generator that can be efficiently used to generate electricity in a relatively small and crowded area such as the roof of a building located in an urban setting. The wind turbine of the invention includes an elongated arm or a pair of axially aligned operatively mounted at its center to the drive shaft of an electric generator. A pair of wind-receiving surfaces or “sails” is respectively mounted at the opposite ends of the arm or arms at each side of the generator drive shaft. As a result of a determination of the direction of the prevailing wind, the arms and sails are positioned such that the wind strikes the sails in opposing directions, one sail being with the wind and the other sail being against the wind. The former remains vertical whereas the opposing wind causes the other sail to pivot downwards to a horizontal position. The wind striking the vertical sail causes the arms to rotate about a central longitudinal axis, which, in turn, rotates the generator drive shaft, thereby to cause the generator to generate electricity in a known manner.

As the arm continues to rotate, the direction of the wind striking the sails is reversed so that the sail that is then vertical is now against the wind and the horizontal sail is now with the wind. At this point, the previously horizontal sail is pivoted upwards to a vertical position and the previously vertical sail pivots downward to a horizontal position. This operation continues such that the sails alternatively pivot upwards and downwards depending on the wind direction, and the arm continues to rotate without interruption to generate electricity.

In a presently preferred embodiment of the invention, the wind turbine includes not one but two axially aligned arms spaced at their inner ends where they are secured to the generator shaft. The sails are respectively mounted for pivotal movement on each of the arms.

In another aspect of the invention, the wind velocity is measured and this measurement is used to move the arms and the sails mounted thereon axially so that at a reduced wind velocity the area of the sail that receives the incident wind is increased so that the rotational torque produced by the incident wind on the vertical sail is augmented to compensate for the reduced wind velocity.

### BRIEF DESCRIPTION OF THE DRAWINGS

To the accomplishment of the above and such further objects as may hereinafter appear, the present invention relates to a wind turbine generator substantially as defined in the appended claims, and as described in the following detailed specification as considered together with the accompanying drawings in which:

FIG. 1 is a perspective of a wind turbine generator according to an embodiment of the present invention shown installed on the roof of a building;

FIG. 2 is a top elevation of the wind turbine of FIG. 1;

FIG. 3 is a side elevation of the wind turbine of FIG. 1;

FIG. 4 is a perspective of the wind turbine of FIG. 1;

FIG. 5 is a top elevation similar to FIG. 2 illustrating the sails in an alternate position;

FIG. 6 is a side elevation similar to FIG. 3 illustrating the sails in an alternate position;

FIGS. 7 and 8 are diagrams for explaining the operation of the wind turbine of the invention;

FIG. 9 is a perspective of the wind turbine of the invention in accordance with an alternate embodiment thereof;

FIGS. 9A and 9B are enlarged details of the wind turbine illustrated in FIG. 9;

FIG. 10 is a perspective illustrating a still further embodiment of the invention; and

FIG. 10A is an enlarged detail of the wind turbine illustrated in FIG. 10.

### DETAILED DESCRIPTION OF THE INVENTION

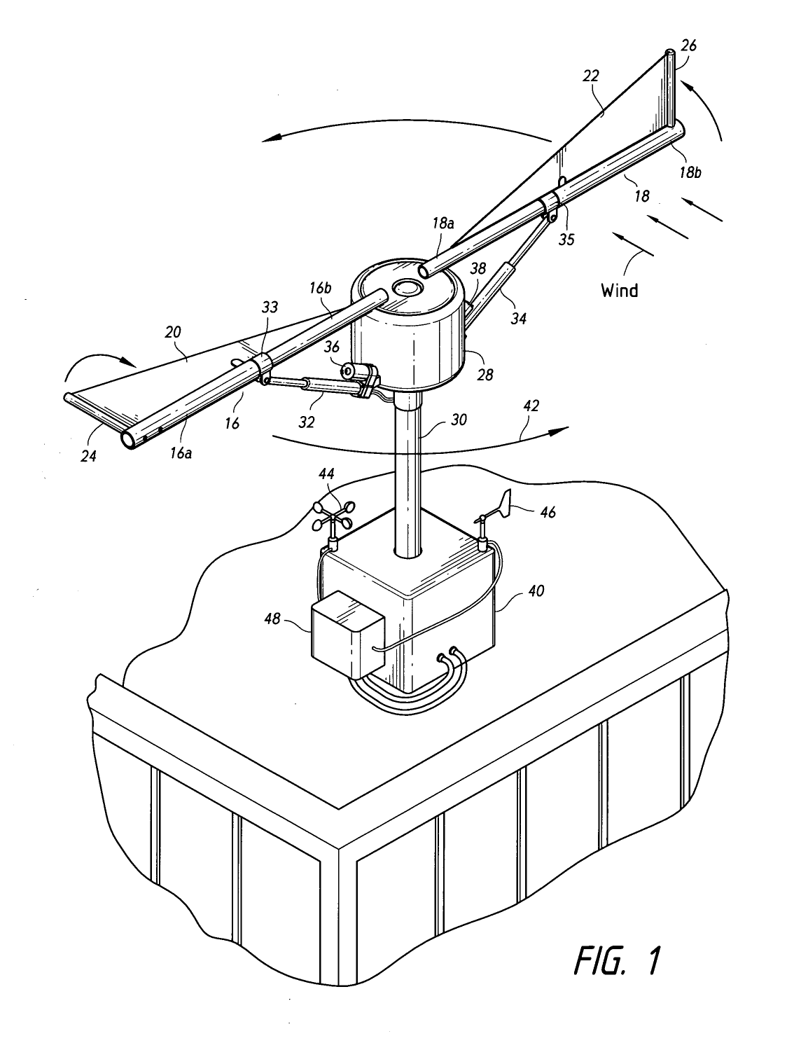

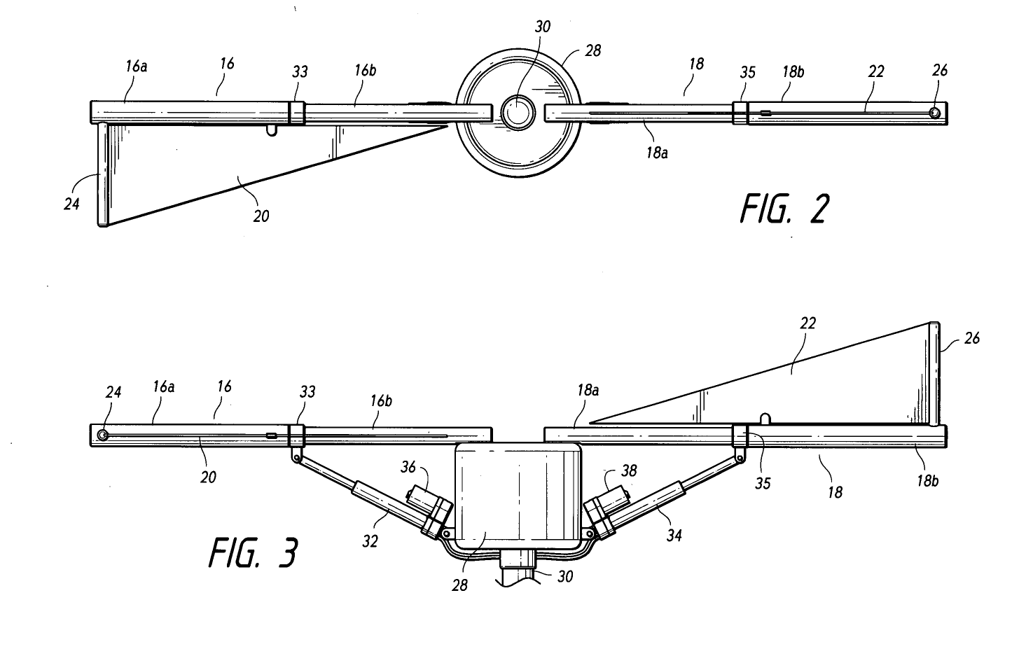

Referring to FIG. 1, there is shown a wind turbine generator according to an embodiment of the present invention, generally designated 10, mounted on the roof 12 of a building 14, such as an apartment house or office building, for use in generating electricity for the residents of the building. As therein shown, the wind turbine 10 comprises a pair of lightweight metal (e.g. aluminum) and axially aligned and spaced arms 16 and 18. each of which, in the embodiment shown, includes a pair of telescoping sections 16a and 16b and 18a and 18b, respectively. Arm sections 16b and 18b are respectively both axially movable along their longitudinal axes and rotatable about those axes with respect to arm sections 16a and 18a.

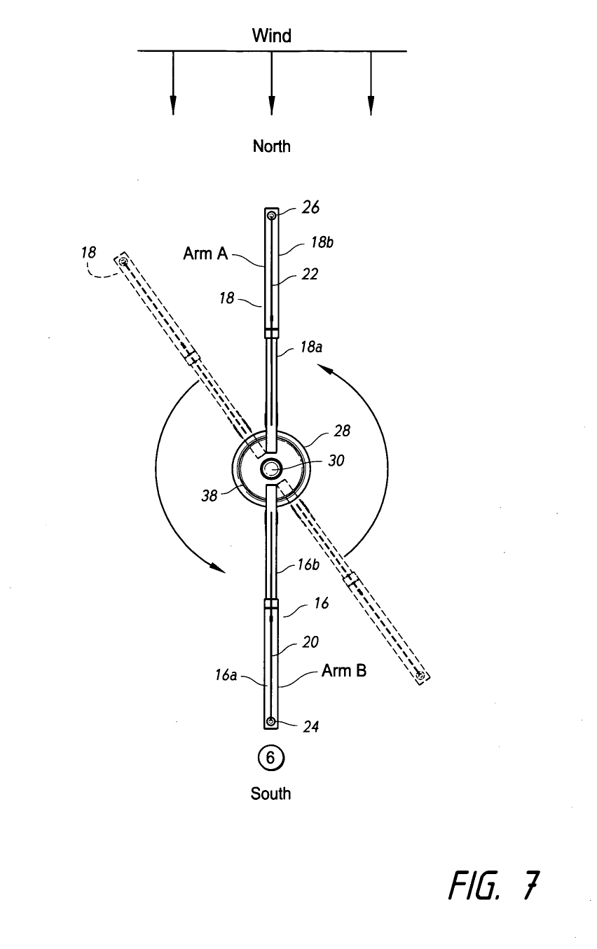

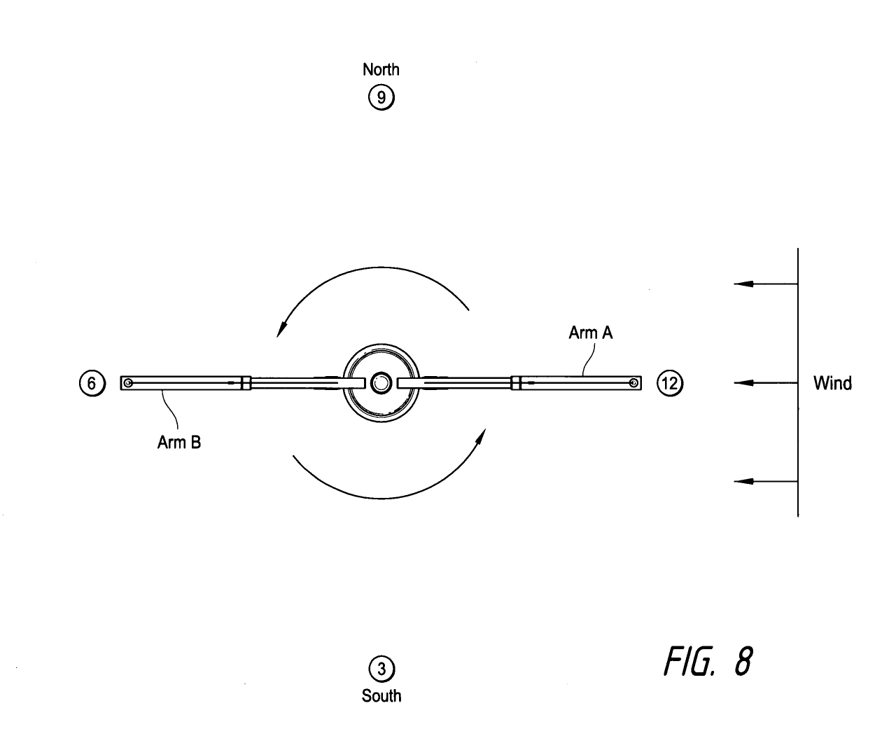

A pair of wind-receiving elements 20 and 22, hereinafter referred to as “sails”, are respectively secured, as can best be seen in FIGS. 5 and 6, to arms 16 and 18 by being received within axial channels provided in arm sections 16b and 18b. Sails 20 and 22 are also respectively supported at their respective outer edges by posts 24 and 26. Sails 20 and 22 are preferably made of a strong but relatively lightweight material such as high-carbon steel or Kevlar that can withstand the force of an incident high-velocity wind.

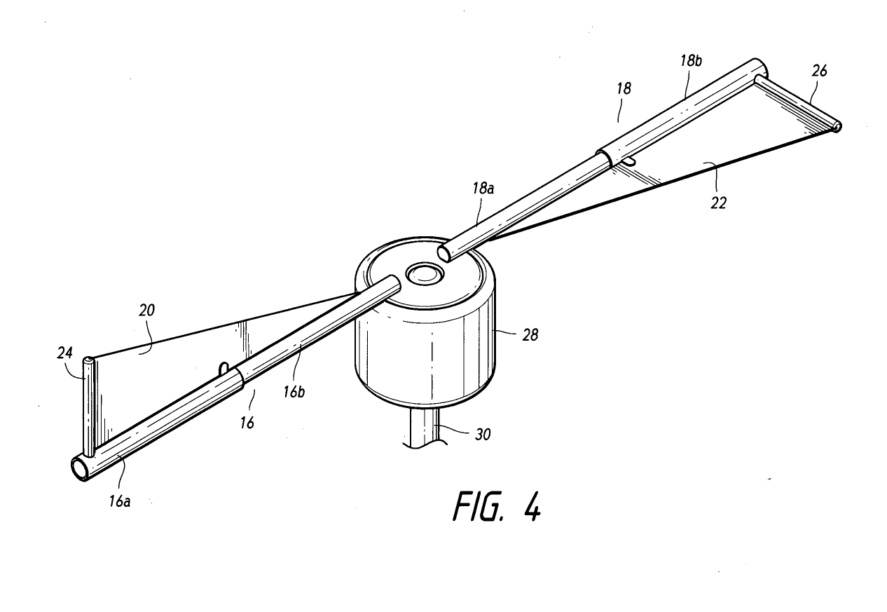

Arm sections 16a and 18a are secured at their inner ends to a rotating hub or drum 28 from which a drive shaft 30 vertically depends. A pair of telescoping struts 32 and 34 extend from hub 28 and are secured respectively at their other ends to arm sections 16b and 18b by means of collars 33 and 35 (FIG. 3). Lightweight motors 36 and 38 are respectively mounted at the inner ends of struts 32 and 34, respectively, for reasons described in greater detail below. Although two arms 16 and 18 are herein shown to support the sails 20 and 22, a single arm secured at its central portion to drive shaft 30 may alternatively be employed to support the sails.

Drive shaft 30 extends into an electrical generator 40, which, as drive shaft 30 rotates, as indicated by the arrow 42, generates electricity in a known manner. Mounted on the generator 40 are a wind-velocity-measuring anemometer 44 and a wind-direction sensor or vane 46, each of which provides data in electrical form to a microprocessor 48 also mounted on generator 40.

Based on the determination of the prevailing wind velocity by anemometer 44, the microprocessor 48 applies a proportional electrical signal to motors 36 and 38 respectively mounted on struts 32 and 34 that, when actuated, respectively cause struts 32 and 34 to either extend, for reduced sensed wind velocity, or retract, for increased sensed wind velocity. This operation causes arm sections 16b and 18b to respectively move axially with respect to arm sections 16a and 18a either inwardly or outwardly, thereby to either decrease or increase the axial extension of the arms 16 and 18, and consequently either to decrease or increase the area of the sails 20 and 22 that are exposed to the incident wind. In this manner the lower the sensed wind velocity the greater will be the axial length of arms 16 and 18 and the area of sails 20 and 22 exposed to the wind. Conversely, for greater sensed wind velocities the arms 16 and 18 and the areas of sails 20 and 22 exposed to the prevailing wind will be reduced. In addition, based on the sensed direction of the incident wind by the direction sensor 46 the microprocessor will send an electrical signal to motors 36 and 38 to rotate the arms 16 and 18 to a position at which one of the sails is vertical while the other sail is horizontal such that the horizontal sail greatly reduces the exposure of the horizontal sail when the sail is moving against the wind direction. Alternatively, a swap gear may be interconnected between the arms 16 and 18 that would automatically move one of the sails to a horizontal orientation while the other sail is being moved to a vertical orientation.

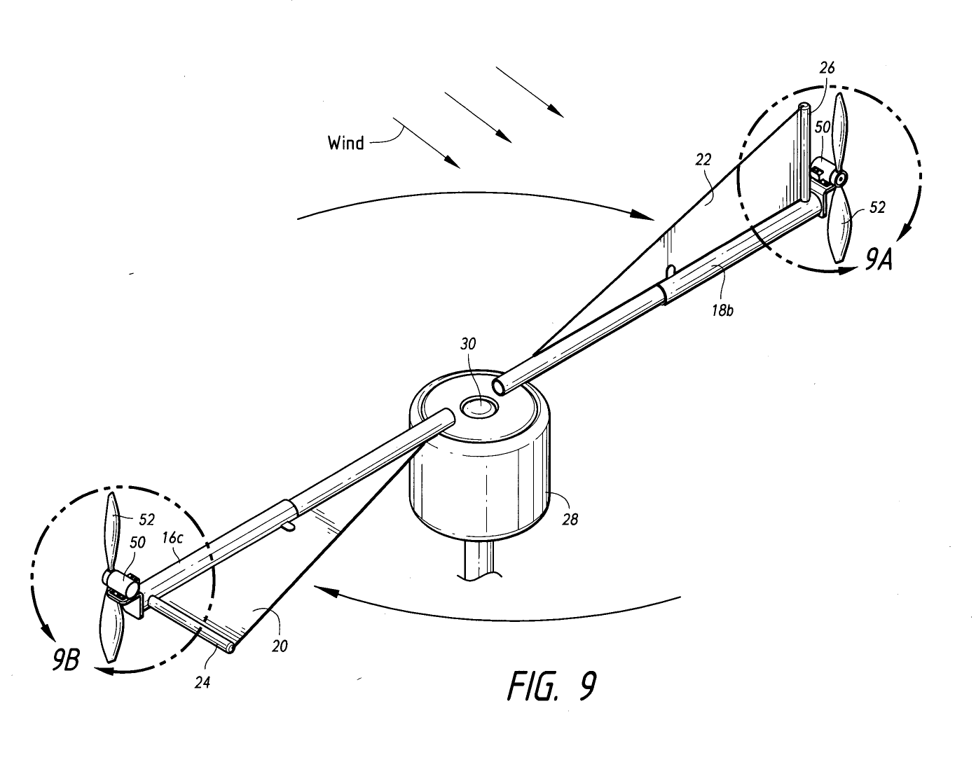

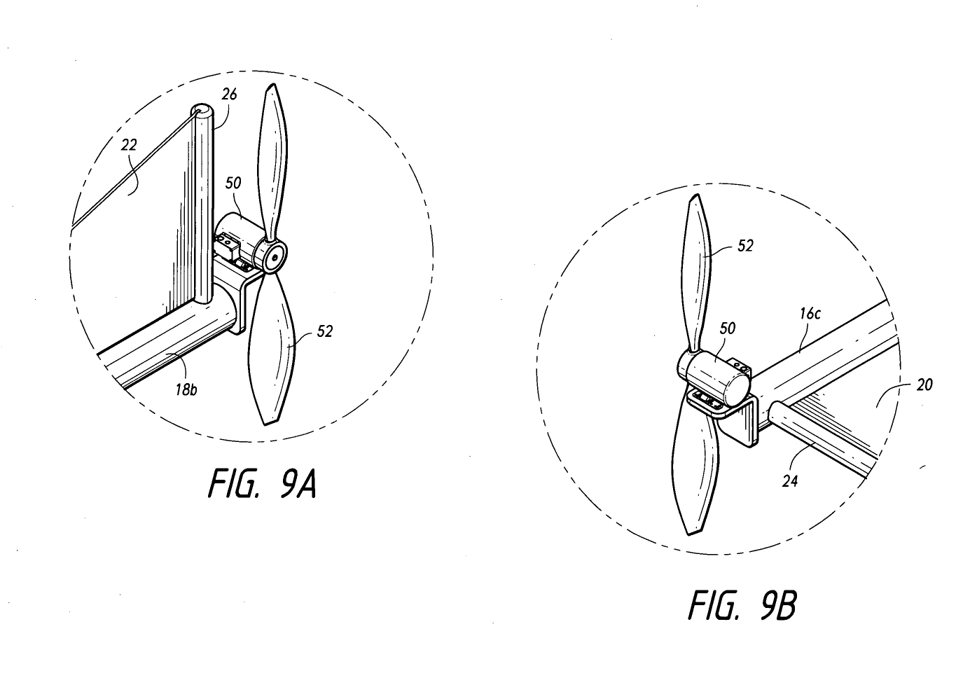

In the example illustrated in FIGS. 7 and 8, it is assumed that arms 16 and 18 are initially axially aligned with the direction of the prevailing wind. Before the wind turbine system of FIG. 1 begins to operate, the microprocessor 48 determines, based on the data provided to it by the wind speed and direction sensors 44 and 46, the extension and angular orientation of arms 16 and 18. As shown in FIG. 7, the wind is assumed to come from the North and parallel to the longitudinal axes of arms 16 and 18 so that no wind is then incident on the sails. The microprocessor 48, sensing this condition, sends a signal to motors 36 and 38 to cause the arms 16 and 18 to rotate slightly in a counter-clockwise direction to the position shown in the broken lines in FIG. 7.

At this position sail 22 carried by arm 18 receives the wind such that arm section 18b is rotated about its longitudinal axis and sail 22 mounted in arm section 18b is rotated upwards to a vertical position (FIG. 5). At the same time sail 20 on arm 16 is against the wind such that arm section 16b and sail 20 carried thereon are rotated, thereby to place sail 20 in a horizontal position at which it offers a greatly reduced resistance to the opposing wind.

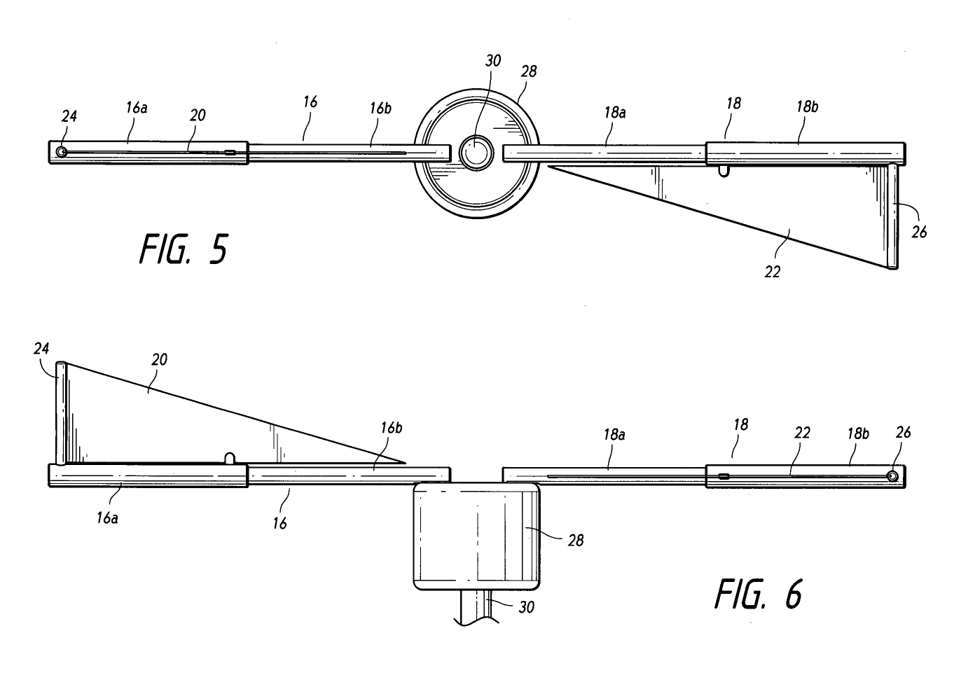

The wind incident on sail 22 continues to rotate the unit 10 until the wind turbine 10 arrives at the position shown in FIG. 8 at which the wind direction is now incident on the then horizontal sail 20 and in a direction opposite to the then vertical sail 22. This, as can be also seen in FIGS. 4, 5 and 6, causes arm section 16b to rotate about its longitudinal axis and sail 20 is thus rotated upwards to a vertical position while sail 22 is rotated downward to a horizontal position (FIG. 6). The wind turbine continues to rotate until it again reaches the position shown in FIG. 7 at which time sail 22 receives the wind causing arm section 18b to rotate about its longitudinal axis to cause sail 22 to be again rotated upward to a vertical position and sail 20 is rotated downward to a horizontal position as a result of the incident wind causing arm section 16b to rotate about its longitudinal axis.

This operation of alternatively raising and lowering sails 20 and 22 and the resulting continuing rotation of wind turbine 10 continues in this manner so long as the wind remains in the same direction. If and when the wind changes its direction, that will be sensed by sensor 46 and the microprocessor 48 will provide a corrective positioning signal to the positioning motors 36 and 38 to ensure that the operation of wind turbine 10 as hereinabove describes continues. This continual rotation of wind turbine 10, as noted, results in the continuous generation of electricity in generator 40 as desired.

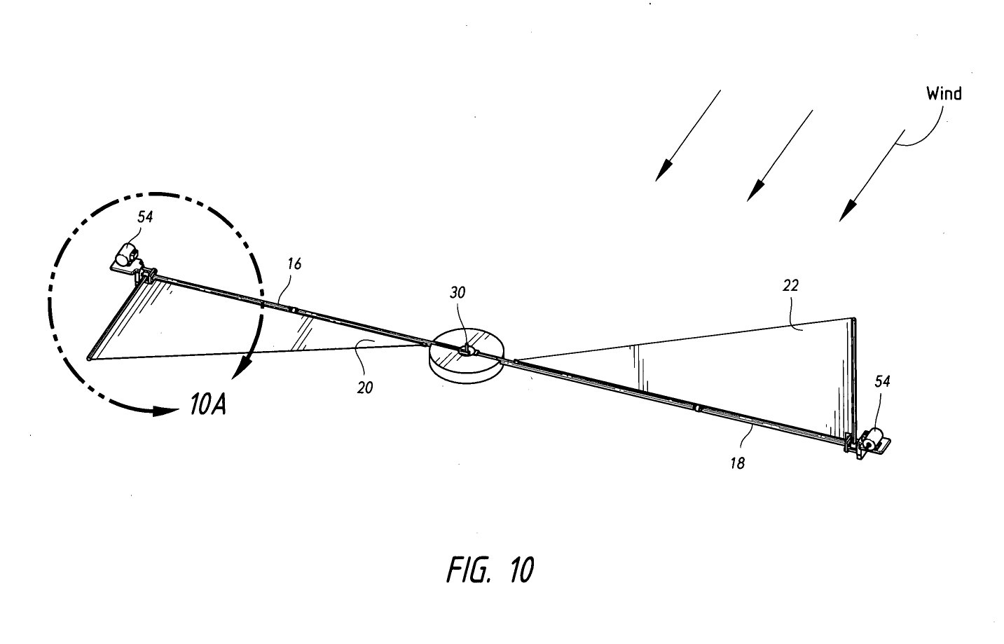

FIG. 9 illustrates an alternate embodiment of the wind turbine of the invention 10a, in which elements corresponding to those in the embodiment of FIG. 1 are designated by corresponding reference numerals. In the embodiment of FIG. 9, a motor 50 is secured to the outer ends of arms 16 and 18, and a fan blade 52 is affixed to the drive shaft of each motor 50. Motors 50 are actuated in response to a signal from microprocessor 48 (not shown in FIG. 9) that is proportional to the sensed wind velocity. When the motors 50 are thus actuated, they cause blades 52 to rotate and create a wind, which acts upon the sails to help move the arms 16 and 18 to the proper orientation as determined by the sensed wind direction

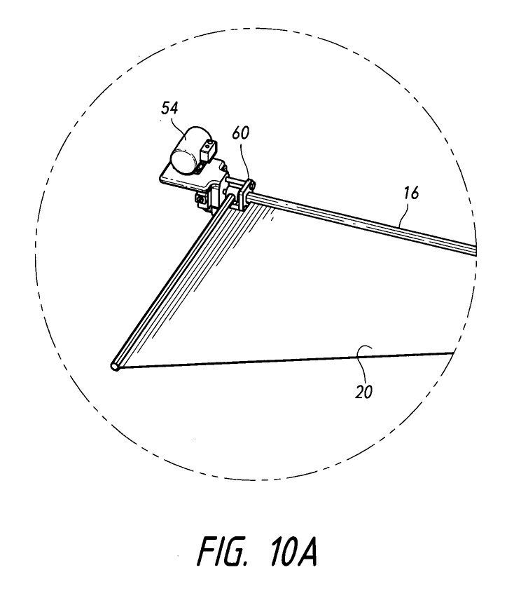

In the embodiment of the invention illustrated in FIG. 10, a counterweight 54 is secured to the outer end of each of arms 16 and 18. The function of the counterweights 54 in the embodiment of FIG. 10 is similar to that of a keel in a sail boat, that is, the counterweights offset the force of the wind that would otherwise force the arms to move laterally. To this end, the counterweights 54 prevent the ends of arms 16 and 18 from being pushed upwards by the force of the wind. As also shown in FIG. 10, a bracket 60 may be mounted at the end of each arm to move along the circular path 56.

Although the wind turbine of the present invention has been hereinabove described with respect to several presently preferred embodiments, it will be understood that modification and variations may be made thereto without necessarily departing from the spirit and scope of the invention.

What is claimed is:

1. A wind turbine comprising at least one arm, first and second wind-receiving members or sails mounted in a common plane at either end of said arm, said arm being mounted for rotation about the central longitudinal axis of an electric generator, and means responsive to the sensed direction of the prevailing for alternatively positioning one of said sails in a vertical orientation to receive the incident wind while causing the other of said sails to be positioned in a horizontal orientation.

2. The wind turbine of claim 1, comprising first and second arms arranged along a common longitudinal axis, spaced at their inner ends and secured at their inner ends to said central longitudinal axis, said sails being carried by said first and second arms, respectively

3. The wind turbine of claim 2, in which each of said first and second arms respectively include first and second axially aligned, telescoping arm sections, said second arm sections being rotatable about the longitudinal axes of said first arm sections, said sails being mounted in said rotatable second arm sections.

4. The wind turbine of claim 3, in which said second arm sections are movable with respect to said first arm sections along the longitudinal axes of said first arm sections.

5. The wind turbine of claim 4, further comprising means coupled to said sail-positioning means for sensing the velocity and direction of the prevailing wind.

6. The wind turbine of claim 5, further comprising means coupled to said wind velocity sensing means for causing axial movement of said second arm sections with respect to said first arm sections, thereby to vary the axial lengths of said first and second arms in response to the sensed wind velocity.

7. The wind turbine of claim 1, further comprising means coupled to said sail-positioning means for sensing the velocity and direction of the prevailing wind

8. The wind turbine of claim 7, further comprising means coupled to said wind velocity sensing means for varying the axial length of said arm in response to the sensed wind velocity.

9. The wind turbine of claim 2, further comprising counterweights affixed to the opposite outer ends of said first and second arms.
